(19) United States
(12) Patent Application Publication
(10) Pub. No.: US 2008/0049292 A1
(43) Pub. Date: Feb. 28, 2008

(54) Micro-mirror array device

(75) Inventors: Daisuke Matsuo, Tokyo (JP); Tetsuya Hidaka, Tokyo (JP)

Correspondence Address: SCULLY SCOTT MURPHY & PRESSER, PC, 400 GARDEN CITY PLAZA, SUITE 300, GARDEN CITY, NY, 11530, US

(73) Assignee: Olympus Corporation, Tokyo (JP)

(21) Appl. No.: 11/895,235

(22) Filed: Aug. 23, 2007

(30) Foreign Application Priority Data
Aug. 24, 2006 (JP) JP 2006-227412

(51) Int. Cl. G02B 26/08

(52) U.S. Cl. 359/224

(57) ABSTRACT

A micro-mirror array device includes a plurality of micro-mirrors, a plurality of elastic members which deflectably support each of the micro-mirrors, and which are disposed symmetrically in a direction of an arrangement of the micro-mirror array which includes the plurality of micro-mirrors, and a plurality of beams which support each of the elastic-members, and which are disposed between the micro-mirrors. Further, the plurality of beams includes beams on outer sides of the micro-mirrors positioned at both ends, which support the elastic members on outer sides.

### CROSS-REFERENCE TO RELATED APPLICATION

The present application is based upon and claims the benefit of priority from the prior Japanese Patent Application No. 2006-227412 filed on Aug. 24, 2006; the entire content of which are incorporated herein by reference.

### BACKGROUND OF THE INVENTION

1. Field of the Invention

The present invention relates to a micro-mirror array device, and in particular, to a micro-mirror array device which is adopted in a WSS (Wavelength Selective Switch) for example.

2. Description of the Related Art

As it has been described in U.S. Pat. No. 6,625,346, WO 02/075410, in the hitherto known technology, it is possible to select an output fiber by changing respective angles of reflection by a plurality of micro-mirrors, for each signal light, after each signal light having a signal channel including a multiple number of wavelengths incident from an input fiber in a WSS (Wavelength Selective Switch) is subjected to spectral separation by a grating.

In U.S. Pat. No. 6,625,346 and WO 02/075410, there is no concrete description of such micro-mirror array used in such WSS. However, for example, as shown in FIG. 9A, FIG. 9B, and FIG. 9C, the micro-mirror array 10 used in such WSS has a rotation axis AA′ of each mirror 11 in a direction of arrangement of the mirror array in which a plurality of mirrors 11 is arranged in one row. Each mirror 11 is deflected around the rotation axis AA′. Accordingly, a structure is such that by changing the angle of reflection of incident light, it is coupled with one of the fibers in a fiber array which includes a plurality of fibers arranged in a direction orthogonal to the rotation axis AA′.

Here, in a case of structuring the micro-mirror array 10 having such effect, for imparting to each mirror 11, a rotation axis in a direction of arrangement of the mirror array, a hinge 12 made of an elastic member is provided on a left and a right side of each mirror 11, and the mirror 11 is required to be deflected in a direction shown by an arrow in FIG. 9B (either a longitudinal direction or a vertical direction) by the twisting of the hinge 12. FIG. 9B shows a BB′ cross-sectional structure of FIG. 9A.

In such array, it is rational that the hinges 12 are structured to be connected to a thin beam 13 between the two mirrors 11. Moreover, the structure is such that each thin beam 13 is supportably connected by a frame member 14 which supports the entire structure.

At this time, in the mirrors 11 at both ends, the hinges 12 of the mirror 11 are connected to the thin beam 13 on one side, and to the frame member 14 of the entire structure, on the opposite side.

The frame member 14, because of a manufacturing process, is used in a state of various layered structures, and in a state of a stress accumulated inside, due to an etching process etc. for forming the mirror 11. It may cause that the frame member 14 is in a state of having a residual stress.

In this case, a stiffness of the thin beam 13 being low as compared to a substantially stiffness of the frame member 14, the thin beam 13 is bent substantially according to the residual stress of the frame member 14. On the other hand, the stiffness being high, the amount of deformation of the thick frame member 14 is small.

Consequently, in the mirror 11 at the end, the thin beam 13 on one side is deformed substantially, and the thick frame member 14 on the opposite side is not deformed. Therefore, upon loosing the balance, it is inclined in a direction (a horizontal direction or a left and right direction) shown by an arrow in the FIG. 9C. FIG. 9C shows an AA′ cross-sectional structure of FIG. 9A.

On the other hand, in the mirror 11 at the center, since the thin beams 13 on both sides are deformed similarly, there is almost no inclination to left and right (refer to FIG. 9C).

Here, each of the mirrors 11 is deflectable in a direction shown by an arrow in FIG. 9B (the longitudinal direction or the vertical direction). However, the mirror 11 cannot be deflected in the direction shown by an arrow in FIG. 9C (the horizontal direction or the left and right direction). Therefore, when the mirror is inclined in the left and right direction, all corrections of a reflection angle of an incident light is impossible.

Thus, in the above-mentioned mirror array used in the WSS, characteristics different from characteristics of other mirrors (concretely, the inclination in the left and right direction, which is not desired) are developed in the mirrors at both ends, and there is a possibility that an optical quality such as the reflection angel of the incident light is declined.

### SUMMARY OF THE INVENTION

The present invention is made in view of the abovementioned circumstances, and an object of the present invention is to provide a micro-mirror array device which is capable of improving an optical quality by suppressing unevenness in characteristics of mirrors in the micro-mirror array device.

To solve the abovementioned issues, and to achieve the object, a micro-mirror array device includes

a plurality of micro-mirrors,

a plurality of elastic members which deflectably support each of the micro-mirrors, and which are disposed symmetrically in a direction of an arrangement of the micro-mirror array which includes the plurality of micro-mirrors, and

a plurality of beams which support each of the elastic-members, and which are disposed between the micro-mirrors, wherein

the plurality of beams includes beams on outer sides of the micro-mirrors positioned at both ends, which support each of the elastic members on outer sides.

According to another aspect of the present invention, a micro-mirror array device includes a plurality of micro-mirrors, a pair of elastic members which deflectably support each of the plurality of micro-mirrors, and which are disposed symmetrically sandwiched each of the micro-mirrors in a direction of an arrangement of the micro-mirrors of the micro-mirror array, and a plurality of beams which are disposed between the plurality of micro-mirrors, for supporting each of the elastic members and beams on outer sides of the micro-mirrors at both ends, wherein the beams of which an amount of deformation corresponding to an external force is substantially same are connected each of the pair of elastic members disposed at the micro-mirrors at both ends of the micro-mirror array.

### BRIEF DESCRIPTION OF THE DRAWINGS

FIG. 1 is a diagram showing an example of a structure of a micro-mirror array device according to a first embodiment of the present invention;

FIG. 2 is a cross-sectional view in which a part of the micro-mirror array device according to the first embodiment is cut at a plate orthogonal to a plane in FIG. 1, along a rotation axis of the micro-mirror;

FIG. 3A and FIG. 3B are diagrams showing in an enlarged form, a part of the micro-mirror array device according to the first embodiment, FIG. 3B is a cross-sectional structure along CC′ line of FIG. 3A;

FIG. 4 is a cross-sectional view showing in an enlarged form, a partial cross-section of a micro-mirror array device according to a second embodiment of the present invention;

FIG. 5A and FIG. 5B are general diagrams showing examples of a structure of the micro-mirror array device according to the second embodiment;

FIG. 6 is a cross-sectional view in which, a part of the micro-mirror array device in FIG. 5A is cut at a plane orthogonal to a plane in FIG. 5A, along a rotation axis of the micro-mirror;

FIG. 7 is a general diagram showing an example of a structure of the micro-mirror array device according to a third embodiment of the present invention;

FIG. 8 is a general diagram showing another example of a structure of the micro-mirror array device according to a modified embodiment of the third embodiment; and

FIG. 9A, FIG. 9B, and FIG. 9C are diagrams showing examples of a structure of a conventional micro-mirror array devices.

FIG. 10 is a diagram showing an example of a structure of a micro-mirror array device according to modified embodiment of all embodiments.

### DETAILED DESCRIPTION OF THE INVENTION

Embodiments of a micro-mirror array device according to the present invention will be described below in detail by referring to the accompanying diagrams. However, the present invention is not restricted to these embodiments.

Further, if not otherwise specified, a structure of one end of a micro-mirror array device is explained. However, a structure of the other side of the micro-mirror array device is the same as the structure of one end side of the micro-mirror array device.

### First Embodiment

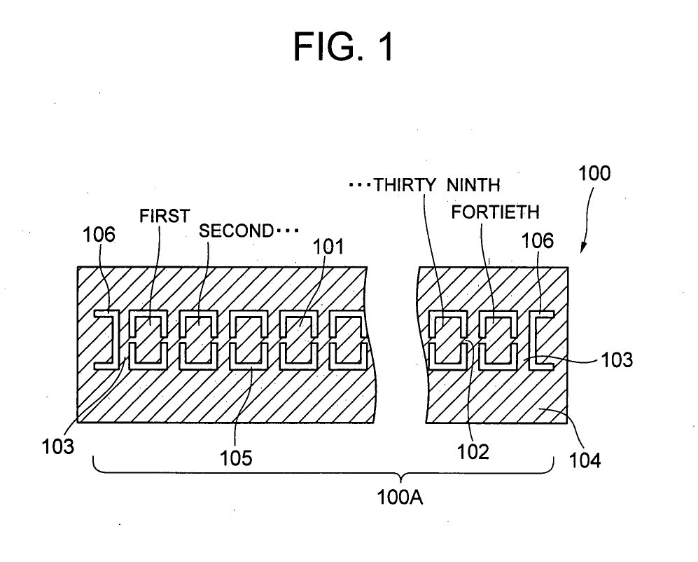

A first embodiment of the present invention will be described below. A micro-mirror array device 100 according to the first embodiment, as shown in FIG. 1, includes at least one row of micro-mirror array (row) in which a plurality of micro-mirrors 101 is disposed in one row. Each of the mirrors (hereinafter, appropriately called as ‘mirrors’) 101 is supported by a pair of hinges 102 disposed symmetrically in a direction of arrangement of the micro-mirror array (rows) with respect to the micro-mirror 101, and a thin beam (hinge supporting portion) 103 for supporting the hinges (elastic members) 102 disposed between the mirrors 101, on a substantial thick frame member (supporting member) 104.

Moreover, in the first embodiment, as shown in FIG. 1, the hinge 102 on an outer side of the mirror 101 at an end is not supported directly by the thick frame member 104, but is supported by the thin beam 103 which is provided between the thick frame member 104 and the mirror 101.

In the micro-mirror array device 100 according to the first embodiment, for example, it is possible to arrange 40 micro-mirrors in a direction of an arrangement. However, 40 mirrors is only an exemplification, and the number of mirrors is not restricted to 40.

In the micro-mirror array device 100 according to the first embodiment shown in FIG. 1 to FIG. 3B, for example, the micro-mirrors 101, the hinges (elastic members) 102, and the beams 103 are formed on an Si substrate in the form of a thin plate, by forming slits 105 and 106 by etching, and forming reflective films by a method such as a vapor deposition.

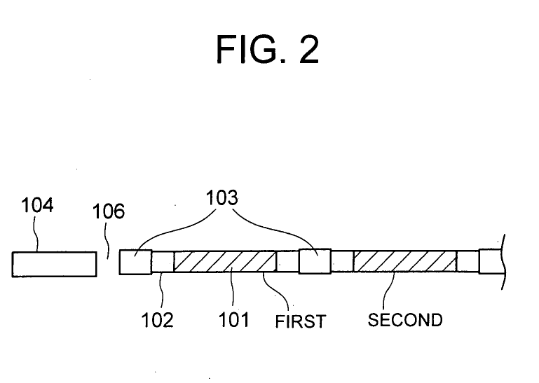

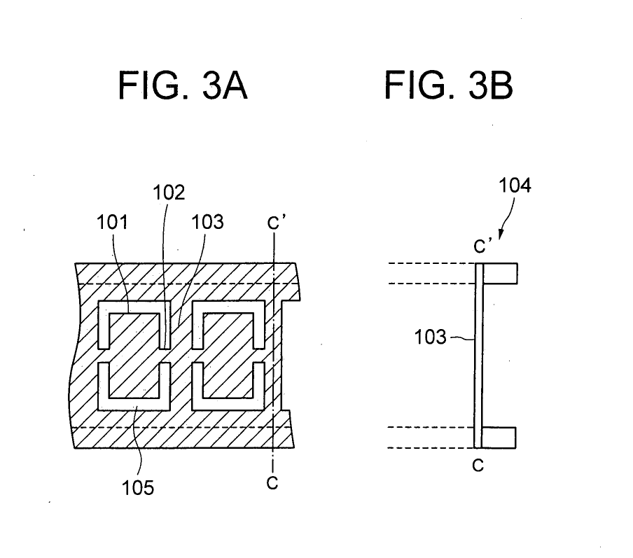

Because of the hinges 102 shown in FIG. 1, FIG. 2, FIG. 3A, and FIG. 3B, it is possible to achieve a micro-mirror array 100A which includes the plurality of micro-mirrors 101 which are deflectable around an axis parallel to the direction of arrangement of the micro-mirrors 101. FIG. 3B is a diagram showing a structure of CC′ cross-section of FIG. 3A.

In the first embodiment, as shown in FIG. 1, the beams 103 are disposed also on outer sides of the mirrors at both ends (a first mirror and a fortieth mirror). In other words, the slit 106 is disposed such that a shape of the beam 103 on the outer side of the first mirror 101 becomes same as a shape of the beam 103 between the first mirror 101 and the second mirror 101. Similarly, by disposing the slit 106 on the outer side of the fortieth mirror 101, the beam 103 is formed.

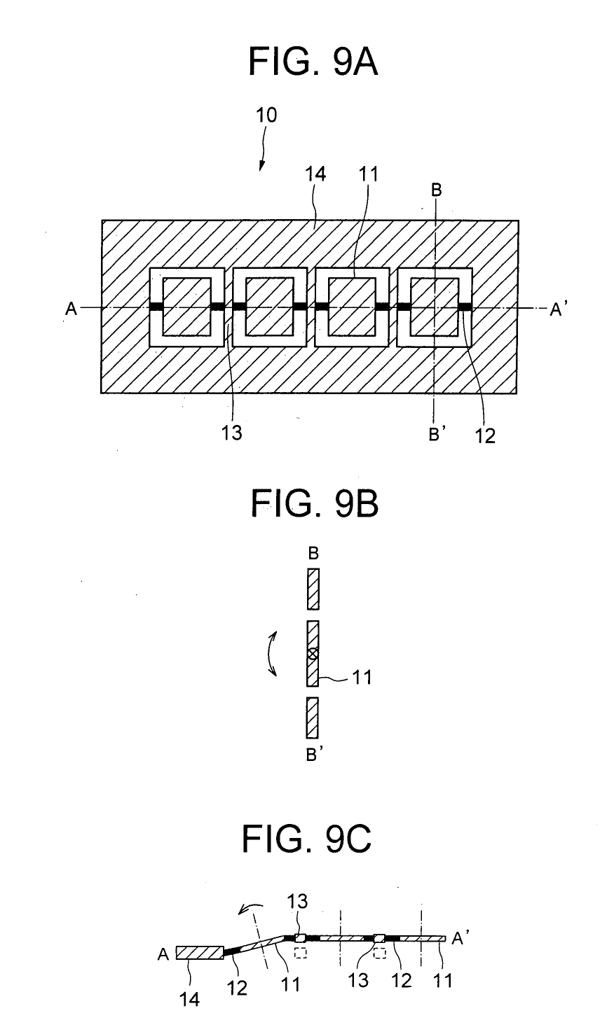

As it has been described earlier by referring to FIG. 9C, as in a conventional technology, when the beam 103 on the outer side is not disposed, since a curvature shape of beams on both sides of the first mirror 101 and the fortieth mirror 101 differs, it had a substantial inclination in the direction of an arrangement (a horizontal direction or a left and right direction). There were cases in which the initial inclination in the adjacent mirrors 101 from the second mirror 101 to the thirty ninth mirror 101 is 10 mdeg or less, whereas, the initial inclination in the adjacent mirrors 101 for the first mirror and the fortieth mirror is 100 mdeg or more.

As shown in FIG. 1 and FIG. 2, by disposing the beam 103 on the outer side of the first mirror 101 and the fortieth mirror 101 as shown in FIG. 2, a relative inclination between the first mirror 101 and the second mirror 101, and the relative inclination between the fortieth mirror 101 and the thirty ninth mirror 101 are improved to be about 10 mdeg for example.

According to the first embodiment which has these characteristics, the beams 103 are formed on both sides of each of the all mirrors 101. Therefore, even for the mirror 101 at the end, it is possible to make a structure in which the hinges 102 on both sides are supported by the thin beams 103. Therefore, it is possible to make a structure same as a structure of the other mirrors 101. Consequently, an amount of distortion of the thin beam becomes constant, and it is possible to suppress the characteristics unnecessary inclination in the mirrors 101 at the both ends. Therefore, it is possible to achieve a micro-mirror array having mirrors of a favorable optical quality.

Moreover, the present invention is capable of showing an effect which is special as compared to the conventional technology. According to this effect, it is possible to solve issues without causing a problem such as an increase in a device size, in a case when a method of providing mirrors which are not used on the outer sides is particularly used, is adopted, and while avoiding a reduction in number of channels by a method in which the mirrors at the both ends are not used.

Moreover, when stiffness (shape) of the beams on both sides of the micro-mirror is let to be almost the same, it is possible to make an amount of deformation due to a stress of the beam to be almost the same for both sides, and it is possible to let the status of all the micro-mirrors to be almost the same.

The beam on an outer side of the mirror at an end is formed by providing a slit in a supporting member which supports the beam. According to this structure, since it is possible to have substantially a same structure as of beams formed on the other portion, by providing a slit in a frame member, it is possible to achieve a desirable effect.

In the present invention, in other words, beams having substantially the same amount of deformation corresponding to an external force are connected to each of a plurality of elastic members disposed on the mirrors which are positioned at both ends of the micro-mirror array. According to the invention provided with this characteristic, it is possible to make same the amount of deformation of beams on both sides of the micro-mirrors at the both ends.

Therefore, it is possible to suppress an unnecessary inclination in the micro-mirrors at the both ends. As it has been described above, in the mirror array, particularly, since a small turning along right and left directions of the mirrors at the both ends has a substantial effect on optical characteristics, it is extremely important that all the mirrors have uniform characteristics.

### Second Embodiment

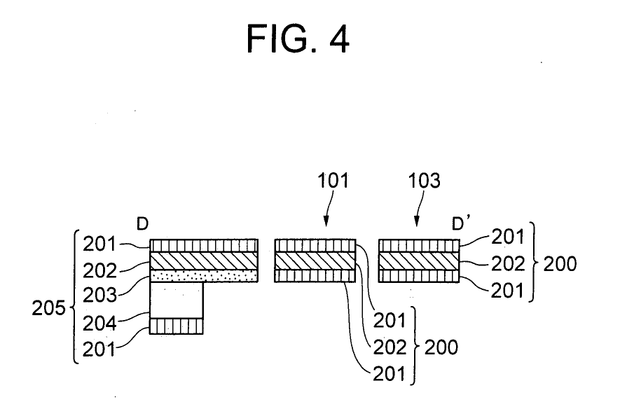

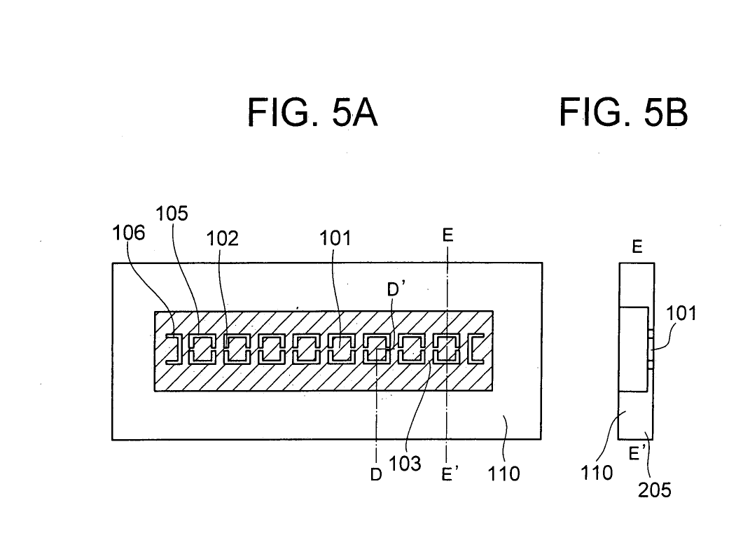

Next, a second embodiment of the present invention will be described below. Same reference numerals are assigned to components which are same as in the first embodiment, and the description to be repeated is omitted. In the second embodiment, an example in which an electrostatically driven micro-mirror array device is structured will be described by referring to FIG. 4, FIG. 5A, and FIG. 5B. FIG. 5B shows a EE′ cross-sectional structure of FIG. 5A. FIG. 4 shows a DD′ cross-sectional structure of FIG. 5A.

A supporting layer 205 of a thickness of about 300 μm, which holds the entire mirror array, is formed. The supporting layer 205, as shown in FIG. 4, includes in order from below, an electroconductive reflective film 201, a micro-structure supporting substrate 204 which is stacked on the electroconductive reflective layer 201, a laminated layer 203 which is stacked on the micro-structure supporting substrate 204, a micro-structure base material 202 which is formed on the laminated layer 203, and an electroconductive reflective film 201 which is formed on the micro-structure base material 202. As shown in FIG. 5A, the micro-mirrors 101, the hinges 102, and the beams 103 are formed by the slits 105 (106) which are formed by the etching process in an active layer (micro-structure) 200 having a thickness of about 10 μm of an inner side of a frame member 110.

The active layer (micro-structure) 200 is formed by an SOI (Silicon On Insulator) substrate etc., and as shown in FIG. 4, includes the electroconductive reflective layer 201, the micro-structure base material 202 which is stacked on the electroconductive reflective film 201, and the electroconductive reflective layer 201 which is stacked on the micro-structure base material 202.

At this time, similarly as described by referring to FIG. 1, the beam 103 is formed also on an outer side of the micro-mirror 101 at an end, and the structure is formed such that the hinge 102 of the micro-mirror 101 at an end is connected to beam 103 (refer to FIG. 5A).

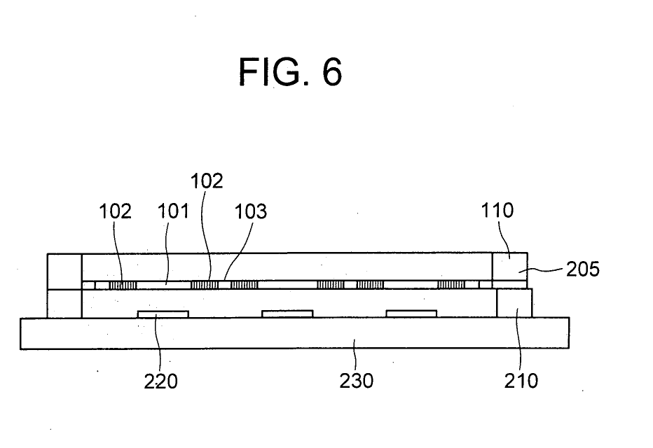

Such micro-mirror array, as shown in FIG. 6, is connected to an electrode substrate 230 having a drive electrode 220 via a spacer 210 having a thickness of about 100 μm, and a micro-mirror array device is formed.

By connecting the micro-mirror 101 to a ground, and applying a voltage to the drive electrode 220, an electrostatic attraction is generated between the micro-mirror 101 and the drive electrode 220, and it is possible to deflect the micro-mirror 101.

When such an arrangement is made, it is possible to form only the supporting layer 205 which supports the entire micro-mirror array by a thick member. Therefore, it is possible to form a thin elastic member which enables deflection of the micro-mirror while avoiding distortion of the entire micro-mirror array.

### Third Embodiment

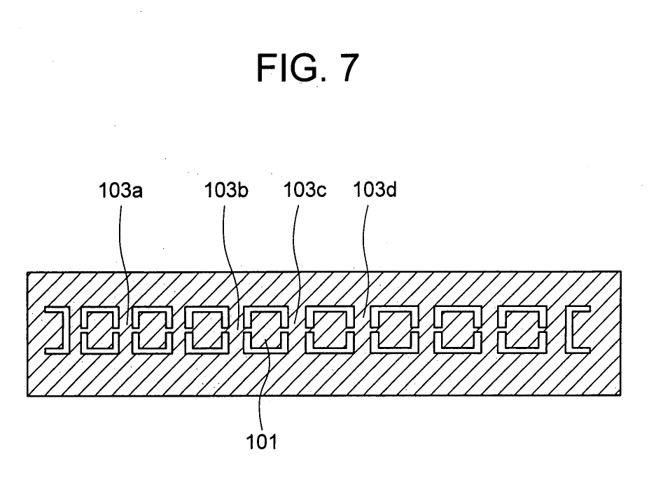

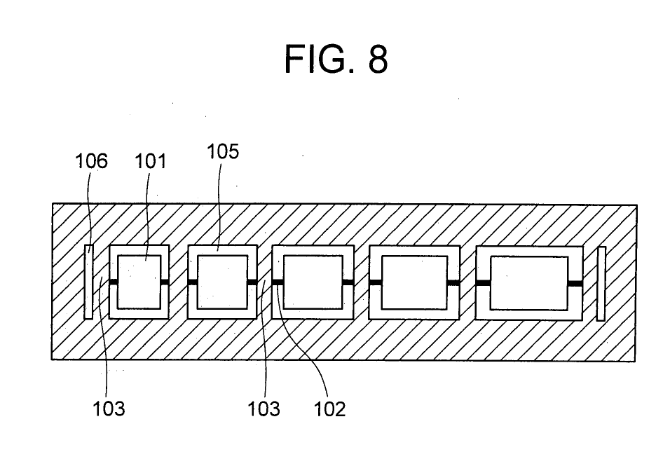

Next, a third embodiment of the present invention will be described below by referring to FIG. 7 and FIG. 8. Same reference numerals are assigned to components same as in the first embodiment and the second embodiment, and the description to be repeated is omitted.

The third embodiment has a structure in which an interval of the micro-mirrors 101 becomes wide from left to right in FIG. 7.

The interval of the micro-mirrors 101 is determined by characteristics of a spectroscope. For example, when a grating is used, a spread angle becomes large gradually toward a long wavelength side than toward a short wavelength side.

In order to deal with this, a structure is required to be such that the interval of the micro-mirrors 101 becomes wide gradually. In such case, including the beams provided outer sides of the micro-mirrors 101 at both ends, as shown in FIG. 7, beams are made thicker gradually in an order of a thin beam 103a, a somewhat thin beam 103b, an intermediate beam 103c, and a somewhat thick beam 103d. By making the beams thicker gradually in such manner, it is possible to achieve an effect of the present invention by structuring a shape of the beams on both sides of with respect to of the micro-mirrors 101 to be almost the same.

By providing this characteristic, even in a case in which the interval of the micro-mirrors 101 in an optical design is changed gradually, and the shape of the beam is changed, when the shape of the beams on both sides of one micro-mirror 101 are almost the same, the stiffness also are almost the same. Therefore, it is possible to achieve a desired effect. In the WSS, according the characteristics of the spectroscope, there are times all intervals between the two mirrors are not constant, and by using the present invention it is possible to solve the issue.

Furthermore, in the present embodiment, it is possible to construct that the width of the micro-mirrors 101 becomes large in accordance with that the beam becomes thick. Meanwhile, it is possible to make all the micro-mirrors 101 to be the same size. The micro-mirrors 101 having the same size have the same driving characteristic. Accordingly, a control of each of the mirror is easier compared to a control of the micro-mirror array consisting of the micro-mirrors having different width, since a condition of the drive control becomes different in a case of the micro-mirror having different width.

### Modified Embodiment

A structure of a modified embodiment is shown in FIG. 8. In FIG. 8, the width (thickness) of the beam 103 is let to be constant compared to the structure shown in FIG. 7. According to optical characteristics, since it is necessary to widen gradually the interval at the center of the micro-mirrors 101, the size of the micro-mirrors 101 is gradually increased in a horizontal direction (direction of a width) in FIG. 8.

A spot diameter of a spectral light beam spot which is converged to each of the micro-mirrors becomes large gradually toward a long wavelength side. Accordingly, when the size in the width direction of the micro-mirror become large toward the long wavelength side, the micro-mirror can catch the spectral beam spot certainly even in a case that a slight assemble error exist.

Moreover, as the mirror interval becomes wide, a beam diameter of light is also supposed to increase. Therefore, increasing the width of the micro-mirror 101 contributes also to improve further the optical quality.

When such an arrangement is made, by making same the stiffness (shape) of the beams 103 on both sides of the micro-mirror 101, the amount of deformation due to the stress of the beams 103 becomes almost the same on both sides, and in addition to becoming same the status of all the micro-mirrors 101, it is possible to secure the widest (largest) size of a reflecting surface of the micro-mirror 101. Therefore, it is possible to minimize an optical loss.

Finally, in a structure in which the beams are formed on outer sides of the micro-mirrors at both ends, mainly a structure in which the slits are provided has been described. However, even in a configuration in which the slit is in the form of a straight line, and in the other form, it is possible to select appropriately. Moreover, it is not restricted to a case of forming the slit by etching, and it is also possible to form the slit by a method such as a pattern cutting. Further, it is not restricted to form the micro-mirrors, the hinges, and the beams integrally from one substrate, and it is also possible to form the micro-mirror array device by combining a plurality of members, as described in the present embodiment.

For making the shape of all the beams and the surrounding thereof as uniform as possible, an idea of making the shape of the slits to be U-shaped as shown in FIG. 1 is also included in a concept of the present invention.

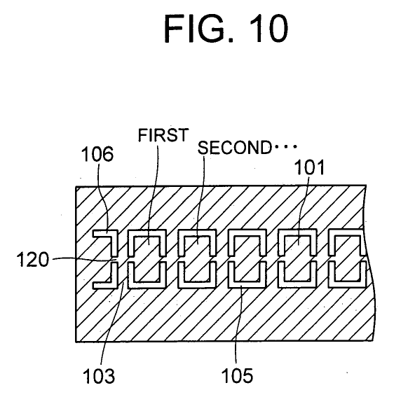

Moreover, it is desirable that for the beam on the outer side of the mirror at the end, an outer elastic member 120 substantially same shape as the elastic member, is formed between the beam and the frame member as shown in FIG. 10. When such an arrangement is made, it is possible to unify a structure of a surrounding of the beam on the outmost side with a structure of surrounding of the other beams, and to make the stiffness of the each beam and the stress exerted on the beam substantially uniform.

In this manner, the present invention can take various modified embodiments which fairly fall within the basic teaching herein set forth.

As it has been described above, the micro-mirror array device according to the present invention is useful as a micro-mirror array device in which a high optical quality is sought, and is suitable as a micro-mirror array device used in the WSS.

According to the micro-mirror array device according to the present invention, an effect is shown that it is possible to improve the optical quality by suppressing unevenness in characteristics between the mirrors.

What is claimed is:

1. A micro-mirror array device comprising:
a plurality of micro-mirrors;
a plurality of elastic members which deflectably support each of the micro-mirrors, and which are disposed symmetrically in a direction of an arrangement of the micro-mirror array which includes the plurality of micro-mirrors; and
a plurality of beams which support each of the elastic-members, and which are disposed between the micro-mirrors, wherein
the plurality of beams includes beams on outer sides of the micro-mirrors positioned at both ends, which support each of the elastic members on outer sides.

2. The micro-mirror array device according to claim 1, wherein
the beams on the outer side of the micro-mirrors positioned at both ends are provided with slits in a frame member which supports the plurality of beams which are disposed between the micro-mirrors.

3. The micro-mirror array device according to claim 2, wherein
the micro-mirrors, the elastic members, and all of the beams, are formed of a thin plate member of an inner side of the frame member.

4. The micro-mirror array device according to claim 1, wherein
in the beams on the outer side of the micro-mirrors at both ends, outer elastic members substantially same shape as the elastic members are formed between the beams on the outer side and the frame member which supports the plurality of beams disposed between the micro-mirrors.

5. The micro-mirror array device according to claim 1, wherein
a stiffness of each of the plurality of beams has substantially same characteristics.

6. The micro-mirror array device according to claim 5, wherein
a width of the beams in the direction of the arrangement of the micro-mirrors is equivalent,
a width of the micro-mirrors in the direction of the arrangement increases gradually in the direction of the arrangement of the micro-mirrors.

7. The micro-mirror array device according to claim 1, wherein
a width of the beams in the direction of the arrangement of the micro-mirrors increases gradually in the direction of the arrangement of the micro-mirrors.

8. A micro-mirror array device comprising:
a plurality of micro-mirrors;
a pair of elastic members which deflectably support each of the plurality of micro-mirrors, and which are disposed symmetrically sandwiched each of the micro-mirrors in a direction of an arrangement of the micro-mirrors of the micro-mirror array; and
a plurality of beams which are disposed between the plurality of micro-mirrors, for supporting each of the elastic members and beams on outer sides of the micro-mirrors at both ends; wherein
the beams of which an amount of deformation corresponding to an external force is substantially same are connected each of the pair of elastic members disposed at the micro-mirrors at both ends of the micro-mirror array.

9. The micro-mirror array device according to claim 8, wherein
the beams on the outer side of the micro-mirrors positioned at both ends are provided with slits in a frame member which supports the plurality of beams which are disposed between the micro-mirrors.

10. The micro-mirror array device according to claim 9, wherein
the micro-mirrors, the elastic members, and all of the beams, are formed of a thin plate member of an inner side of the frame member.

11. The micro-mirror array device according to claim 8, wherein
in the beams on the outer side of the micro-mirrors at both ends, outer elastic members substantially same shape as the elastic members are formed between the beams on the outer side and the frame member which supports the plurality of beams disposed between the micro-mirrors.
